(19) United States
(12) Patent Application Publication
(10) Pub. No.: US 2008/0180467 A1
(43) Pub. Date: Jul. 31, 2008

(54) ULTRA-RESOLUTION DISPLAY TECHNOLOGY

(75) Inventors: Christopher O. Jaynes, Lexington, KY (US); Stephen B. Webb, Lexington, KY (US); Randall S. Stevens, Lexington, KY (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: MERSIVE TECHNOLOGIES, INC., Lexington, KY (US)

(21) Appl. No.: 12/055,721

(22) Filed: Mar. 26, 2008

Related U.S. Application Data
(63) Continuation-in-part of application No. 11/735,258, filed on Apr. 13, 2007.
(60) Provisional application No. 60/896,959, filed on Mar. 26, 2007.
(60) Provisional application No. 60/744,799, filed on Apr. 13, 2006.

(51) Int. Cl. G09G 5/02

(52) U.S. Cl. 345/698

(57) ABSTRACT

The present invention relates to ultra-resolution displays and methods for their operation. According to one embodiment of the present invention, an ultra-resolution display is provided where a common display screen is displaced from an array of display devices such that native frustums of respective ones of the display devices are expanded to define modified frustums that overlap on the common display screen. An image processor is programmed to execute an image blending algorithm that is configured to generate a blended image on the common display screen by altering input signals directed to one or more of the display devices. In this manner, the system can be operated to render an output image that is composed of pixels collectively rendered from the plural display devices. As a result, the resolution of the rendered video can exceed the video resolution that would be available from a single display. Additional embodiments of the present invention are contemplated including, but not limited to, methods of generating ultra-resolution images.

### CROSS-REFERENCE TO RELATED APPLICATIONS

This application claims the benefit of U.S. Provisional Application Ser. No. 60/896,959 (MES 0010 MA), filed Mar. 26, 2007 and is a continuation-in-part of copending and commonly assigned U.S. patent application Ser. No. 11/735258 (MES 0002 PA), filed Apr. 13, 2007, which application claims the benefit of U.S. Provisional Application Ser. No. 60/744,799 (MES 0002 MA), filed Apr. 13, 2006.

This application is also related to commonly assigned, copending, and published U.S. patent applications US 2007-0188719-A1 (MES 0001 PA), US 2007-0268306-A1 (MES 0003 PA), US 2007-0273795-A1 (MES 0005 PA), and US 2007-0195285-A1 (MES 0009 PA), the disclosures of which are incorporated herein by reference.

### BRIEF SUMMARY OF THE INVENTION

The present invention relates to ultra-resolution displays and methods for their operation. According to one embodiment of the present invention, an ultra-resolution display is provided where a common display screen is displaced from an array of display devices such that native frustums of respective ones of the display devices are expanded to define modified frustums that overlap on the common display screen. An image processor is programmed to execute an image blending algorithm that is configured to generate a blended image on the common display screen by altering input signals directed to one or more of the display devices. In this manner, the system can be operated to render an output image that is composed of pixels collectively rendered from the plural display devices. As a result, the resolution of the rendered video can exceed the video resolution that would be available from a single display.

Additional embodiments of the present invention are contemplated including, but not limited to, methods of generating ultra-resolution images.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a schematic illustration of an ultra-resolution display according to one embodiment of the present invention;

FIG. 2 is a schematic illustration of the manner in which a multi-display image rendering system can be used to process image data for an ultra-resolution display according to one embodiment of the present invention; and

FIG. 3 is a flow chart illustrating a method of operating a multi-display image rendering system.

### DETAILED DESCRIPTION

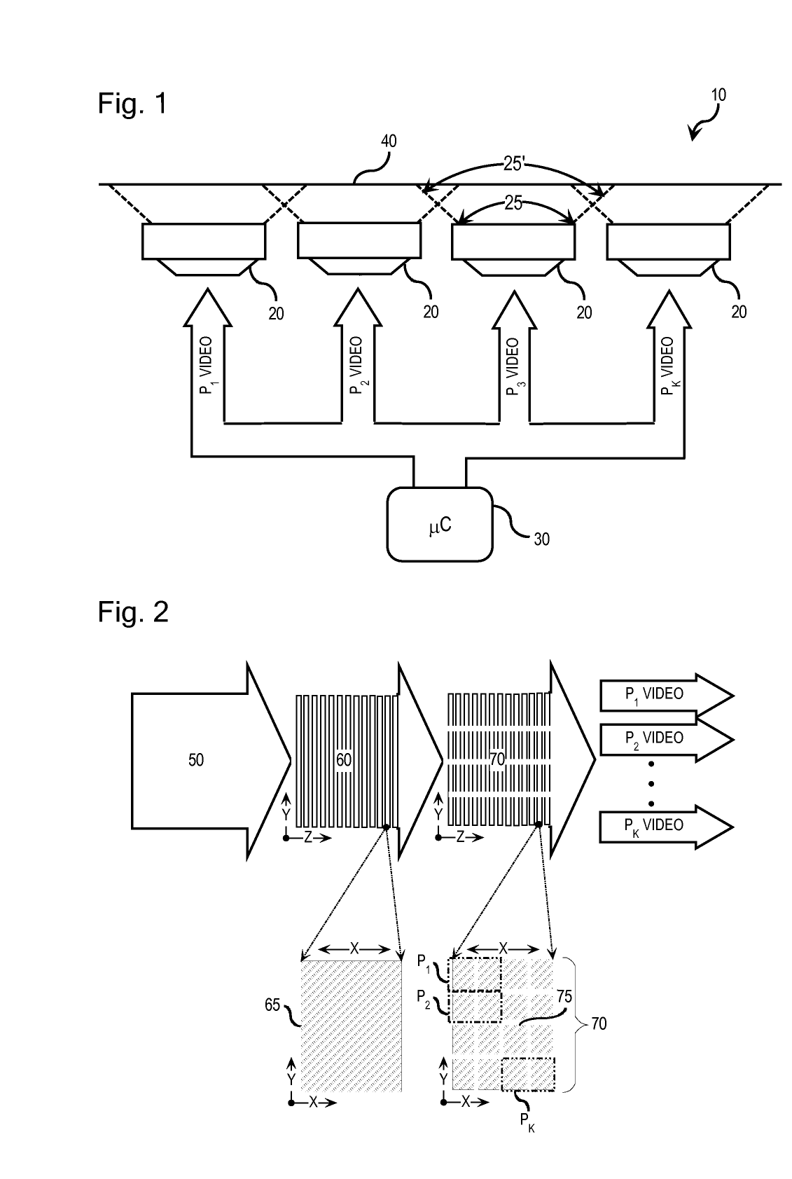

An ultra-resolution display 10 configured according to one specific embodiment of the present invention is presented in FIG. 1. In FIG. 1, the ultra-resolution display 10 comprises a plurality of display devices 20, an image processor 30, and a common display screen 40. The common display screen 40 is displaced from the display devices 20 by a screen displacement d to expand the native frustums 25 of the display devices 20 to modified frustums 25′ corresponding to the screen displacement d. As is illustrated in FIG. 1, the modified frustums 25′ overlap on the common display screen 40. Although each display device 20 illustrated in FIG. 1 is displaced from the common display screen 40 by roughly the same distance d it is contemplated that the respective displacements d corresponding to each display device 20 can vary.

To accommodate for the frustum overlap, the image processor 30 is programmed to execute an image blending algorithm that is configured to generate a blended image on the common display screen 40 by altering input signals directed to one or more of the display devices 20. As a result, the output resolution of the ultra-resolution display 10 at the common display screen 40 can surpass the resolution of respective input signals P₁, P₂, P₃, . . . P_{K} that are directed to the display devices 20. Of course, the image blending algorithm can take a variety of forms, examples of which may be gleaned from conventional or yet-to-be developed technology, examples of which are described below and presented in the above-noted copending applications, the disclosures of which have been incorporated by reference (see US 2007-0188719-A1, US 2007-0268306-A1, US 2007-0273795-A1, and US 2007-0195285-A1).

It is contemplated that the image blending algorithm can be configured to correct for geometric distortion, intensity errors, and color imbalance in the blended image by modifying pixel intensity values in those portions of the input signals that correspond to overlapping pixels in the modified frustums of adjacent display devices. Typically, pixel intensity values of both display devices contributing to the overlap will be modified. However, it is contemplated that the image blending algorithm can be configured to modify only the pixel intensity values of one of a selected pair of adjacent display devices, e.g., by simply turning-off pixel intensity values from one of the adjacent display devices for the overlapping pixels.

According to one embodiment of the present invention, the image blending algorithm is configured to convert an input video stream into sub-image video blocks representing respective spatial regions of the input video stream. Individual video block subscriptions are then identified for each of the display devices so the display devices can be operated to display image data corresponding to the identified video block subscriptions. In this manner, the display devices collectively render a multi-display image representing the input video stream. It is contemplated that the video block subscriptions for each of the display devices can be identified by matching a frustum of each display device with pixels of the sub-image video blocks and by matching the frustum of each display device with pixels of the sub-image video blocks. A more detailed description of the manner in which an image processor can be used to blend overlapping portions of video block subscriptions is presented below, with additional reference to alternative schemes for image blending, none of which should be taken to limit the scope of the present invention.

According to one aspect of the present invention, noting that the modified frustums 25′ of the display devices 20 are larger than their native frustums 25, it is further contemplated that the image blending algorithm can be configured to operate on a variable displacement input. More specifically, the algorithm can be configured to operate with a variety of different screen displacement values d, rendering the ultra-resolution display 10 operable at a plurality of different screen displacements d.

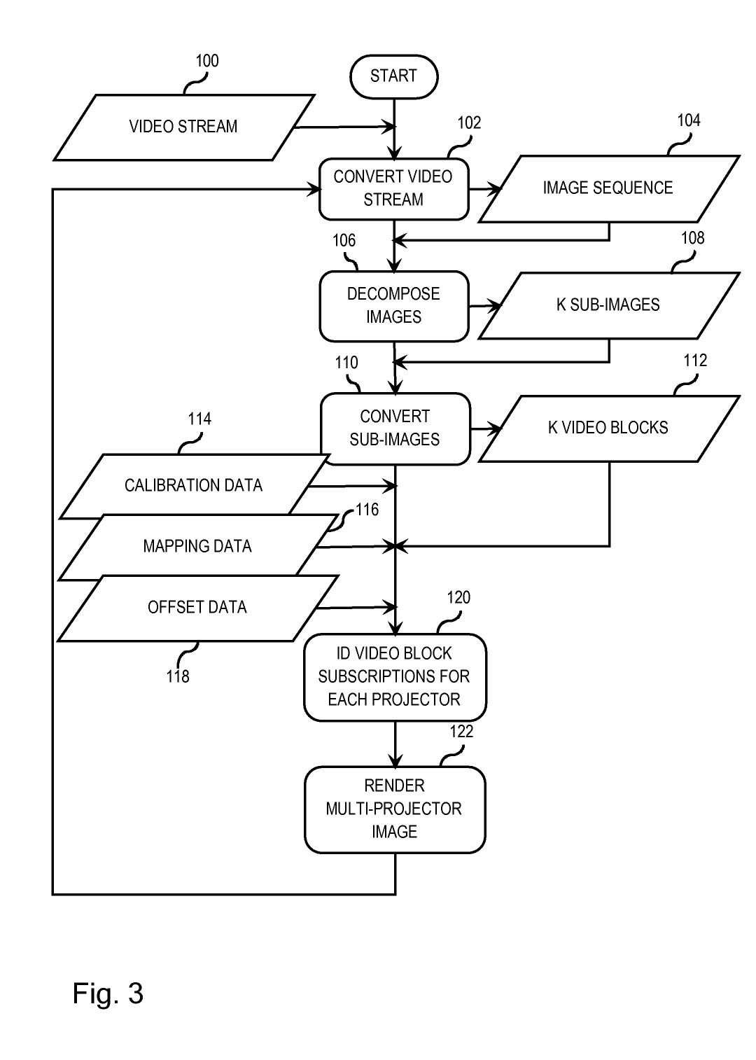

One example of the manner in which a multi-display image rendering system can be used to process image data for an ultra-resolution display is illustrated herein with reference to FIGS. 2 and 3. As is noted above, the example illustrated in FIGS. 2 and 3 should not be taken to limit the scope of the present invention. In operation, an image processor can be programmed to convert an input video stream 50 into a sequence 60 of images 65 that are relatively static when compared to the dynamic input video stream (see blocks 100, 102). These relatively static images 65 are decomposed into respective sets 70 of sub-images 75 (see blocks 104, 106) such that each sub-image set 70 comprises a set of k sub-images 75. Typically, the static images are decomposed into respective sets of sub-images 75 that collectively contain the complete set of data comprised within the input video stream 50.

The decomposed sub-images 75 are converted to into k independently encoded sub-image video blocks P₁, P₂, P_{K}, each representing respective spatial regions of the input video stream 50 (see blocks 108, 110, 112). More specifically, each of the k sub-image video blocks P₁, P₂, P_{K} will correspond to one or more of the k spatial regions of the static images. As is illustrated in FIG. 2, the resolution of each sub-image 75 is lower than the resolution of each static image 65 and the sub-image sets 70 collectively represent the input video stream 50. It is contemplated that the sub-image video blocks P₁, P₂, P_{K} can represent overlapping or non-overlapping spatial regions of the input video stream. It is further contemplated that it may not always be preferable to encode the sub-image video blocks P₁, P₂, P_{K} independently, particularly where completely independent encoding would result in artifacts in the rendered image. For example, block edge artifacts in the recomposed image may be perceptible if MPEG encoding used. It may be preferable to read some information from neighboring image blocks during the encoding process if these types of artifacts are likely to be an issue.

To render a multi-display image, video block subscriptions are identified for each of the display devices 20 and the display devices 20 are operated to display image data corresponding to the identified video block subscriptions (see blocks 120, 122). For example, the video block subscriptions for each of the display devices 20 can be identified by matching a frustum of each display device 20 with pixels of the sub-image video blocks. Alternatively, a pixelwise adjacency table representing all of the displays can be used to determine which video blocks should be identified for construction of the respective video block subscriptions. In either case, the display devices 20 will collectively render the multi-display image such that it represents the input video stream.

To facilitate enhanced image display, the frustum of each display device 20 is determined by referring to the calibration data for each display device (see block 114). Although it is contemplated that the calibration data for each display device 20 may take a variety of conventional or yet to be developed forms, in one embodiment of the present invention, the calibration data comprises a representation of the shape and position of the vertex defining the view frustum of the display device of interest, relative to the other display devices within the system. The display frustum of each display device 20 can also be defined such that it is a function of a mapping from a virtual frame associated with each display device 20 to a video frame of the rendered image. Typically, this type of mapping defines the manner in which pixels in the virtual frame translate into spatial positions in the rendered image. Finally, it is contemplated that the frustum of each display device 20 can be matched with pixels of the sub-image video blocks P₁, P₂, P_{K} by accounting for spatial offsets of each sub-image video block in the rendered image and by calibrating the display devices 20 relative to each other in a global coordinate system.

For example, consider a multi-display video display in which two host computers are connected to two displays mounted side-by-side to produce a double-wide display. The left display and host computer do not require data that will be displayed by the right host computer and right display. Accordingly, once the original data has been encoded into a set of video blocks, only the video blocks required by the particular host computer display pair are decoded. For the left display, only the sub-image blocks from the left half of the original input image sequence are required. Similarly, for the right display, only the sub-image blocks from the left half of the original image sequence are required. In this manner, computational and bandwidth costs can be distributed across the display as more computers/displays are added to increase pixel count.

Typically, a computer/display determines which sub-image blocks are required by computing whether the display frustum overlaps with any of the pixels in the full-resolution rendered image contained in a given video block. Several pieces of information are required in order to compute the appropriate video block subscriptions for each display device. Referring to the example of the left/right display configuration above, the left display/computer pair must be able to know the shape and position of each vertex describing its view frustum with respect to the right display. The relative position of the different display frame buffers define a space that can be referred to as the virtual frame buffer as it defines a frame buffer (not necessarily rectangular) that can be larger than the frame buffer of any individual computer/display. Secondly, a mapping from the video frame to the virtual frame buffer must be known. This mapping can be referred to as the movie map and designates how pixels in the virtual frame buffer map to positions in the full movie frame. Finally, the offsets of each block in the full move frame must be known. Given this information, each displayed frustum, and the corresponding computer that generates images for that display, can subscribe to video blocks that overlap with that display's frustum.

More specifically, once the decomposed sub-images 75 are converted to into k independently encoded sub-image video blocks P₁, P₂, P_{K}, each representing respective spatial regions of the input video stream 50, the respective video blocks are ready for transmission from the image processor. When transmission of the video blocks is initiated the image processor can be configured to choose to accept, not accept, or otherwise select the transmission of a particular sub-image sequence, depending at least in part on the display's geometric calibration. According to one contemplated embodiment of the present invention, this operation could be carried out by configuring the image processor to create one UDP/multicast channel for each sub-image sequence. In which case, the image processor would determine which sub-image sequences are required, and subscribe to the corresponding multicast channels. In this way, the receiving hardware would receive and process only the sub-image sequences that are required, and ignore the other sub-image sequences.

Because the present invention relates to multi-display displays where the sub-image video blocks P₁, P₂, P_{K} can represent overlapping spatial regions of the input video stream, it may be preferable to configure the image processor to blend overlapping portions of the video block subscriptions in the rendered image. The specific manner in which video block blending is executed is beyond the scope of the present invention.

Referring to FIG. 2, in one specific embodiment of the present invention, the input video stream 50 comprises a sequence of rectangular digital images, e.g., a sequence of JPEG images, an MPEG-2 video file, an HDTV-1080p broadcast transmission, or some other data format that can be readily decoded or interpreted as such. The input video sequence 50 is processed and decoded to the point where it can be spatially segmented into sub-image video blocks P₁, P₂, P_{K}. In the case of JPEG images, for example, the images could be partially decoded to the macroblock level, which would be sufficient to spatially segment the image.

Once the image sequence 60 has been decoded to raw image data, the video stream processor segments each image in the sequence to generate the respective sets 70 of sub-images 75. In the embodiment at hand, the segmentation step decomposes each image into a set of rectangular sub-images. In the most straightforward form, the sub-images are all the same size, and do not overlap each other. For example, an input image with resolution 1024×768 pixels could be divided into 4 columns and 3 rows of 256×256 sub-images, giving 12 non-overlapping sub-images. Note that it is not required that the sub-images have the same resolution, nor is it required that the sub-images avoid overlap with one another. The only requirement is that the original image can be completely reproduced from the set of sub-images and that the segmentation geometry remains the same for all images in the input image sequence. The result of the processing step is a collection of sub-image sequences that, taken together, fully represent the input image sequence. This collection of sub-image sequences may be encoded to the original (input image) format, or to some other format. For example, a sequence of 1024×768 JPEG images, after processing, may be represented as 12 256×256 JPEG image sequences, or 12 256×256 MPEG-2 encoded video sequences.

The next step is the storage and transmission of the processed video stream, which can also be handled by an image processor. First, the processed sub-image sequences are saved. The sub-image sequences are stored together, along with additional data describing the format and structure of the sub-image sequences. This additional data helps re-create the original image sequence from the sub-image sequences. These may be stored together in a database, as a single file, or as a collection of individual files, as long as each sub-image sequence can be retrieved independently and efficiently. As is noted above, the sub-image video blocks P₁, P₂, P_{K} can be transmitted to the display devices after permanent storage of the processed video stream is complete.

In many cases, it may be necessary to utilize additional software components, e.g., MPEG-2 decoding library software, to decode the sub-image video blocks P₁, P₂, P_{K} prior to display depending, at least in part, on the format of the sub-image sequences. The correct image can be generated from the decoded sub-image sequences based on the geometric calibration of the display, i.e., the correspondence between pixels in a given display and the pixels of the original input video stream. By using this geometric calibration, the image rendering software determines which sub-image sequences contain data relevant to a given display. Once the relevant sub-image sequences have been retrieved and decoded, a geometrically correct image is generated and displayed. The image is geometrically correct in the sense that the final displayed image contains the corresponding pixels of the original input image as described by the geometric calibration. The geometric calibration system can be designed so that the resulting composite image, as displayed from multiple displays, generates a single geometrically consistent image on the display surface.

In addition to the decoding and geometric correction of the sub-image sequences, the video decoding and display software residing in the image processor can be configured to communicate with centralized synchronization software residing in the image processor, in order to ensure temporally consistent playback among all instances of the video decoding and display software. Other contemplated methods of synchronization involve direct communication between the image processors. For example, the image processors could collectively broadcast a “Ready” signal to all other image processors and when each image processor has received a predetermined number of “Ready” signals, the frame would be displayed.

Although the operation of the image rendering systems of the present invention have generally been described as independent sub-processes happening in sequence, it may be preferable to run some or all of the processes simultaneously. For example, if the input image sequence is a broadcast video feed, it would be desirable to process, distribute and display the incoming video stream simultaneously. In such a configuration, certain steps would be restricted or bypassed. For example the permanent storage to disk may not be desirable, and instead the encoded sub-image sequences, or parts thereof, could be transmitted via the network. Aside from some buffering and transmission overhead, the video stream would be processed, transmitted and displayed simultaneously, as it is received from the broadcast source.

For the purposes of describing and defining the present invention, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present invention being “programmed” in a particular way, “configured” or “programmed” to embody a particular property or function in a particular manner, are structural recitations as opposed to recitations of intended use. More specifically, the references herein to the manner in which a component is “programmed” or “configured” denotes an existing physical condition of the component and, as such, is to be taken as a definite recitation of the structural characteristics of the component.

It is noted that terms like “preferably,” “commonly,” and “typically,” if utilized herein, should not be taken to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue. The term “substantially” is further utilized herein to represent a minimum degree to which a quantitative representation must vary from a stated reference to yield the recited functionality of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. An ultra-resolution display comprising a plurality of display devices, a common display screen, and an image processor, wherein:
the common display screen is displaced from the display devices by a screen displacement d such that native frustums of respective ones of the display devices are expanded to define modified frustums that overlap on the common display screen; and
the image processor is programmed to execute an image blending algorithm that is configured to generate a blended image on the common display screen by altering input signals directed to one or more of the display devices.

2. A method of generating an ultra-resolution display utilizing a plurality of display devices, the method comprising:
replacing native display screens associated with the display devices with a common display screen displaced from the native display screens of the display devices by a screen displacement d to expand the native frustums of the display devices to modified frustums corresponding to the screen displacement d such that the modified frustums of the display devices are larger than the native frustums of the display devices and overlap on the common display screen; and
generating a blended image on the common display screen to blend overlapping image portions of the modified frustums such that the output resolution of the ultra-resolution display at the common display screen surpasses the resolution of respective input signals directed to the display devices.

3. An ultra-resolution display as claimed in claim 1 wherein the image blending algorithm modifies input signal portions corresponding to overlapping pixels in the modified frustums of adjacent display devices by modifying pixel intensity values of adjacent display devices.

4. An ultra-resolution display as claimed in claim 1 wherein the image blending algorithm modifies input signal portions corresponding to overlapping pixels in the modified frustums of adjacent display devices by modifying pixel intensity values of only one of a selected pair of adjacent display devices.

5. An ultra-resolution display as claimed in claim 1 wherein the image blending algorithm modifies input signal portions corresponding to overlapping pixels in the modified frustums of adjacent display devices by turning off pixel intensity values of one of the adjacent display devices for the overlapping pixels.

6. An ultra-resolution display as claimed in claim 1 wherein the image blending algorithm is configured to correct for geometric distortion in the blended image.

7. An ultra-resolution display as claimed in claim 1 wherein the image blending algorithm is configured to correct for intensity errors in the blended image.

8. An ultra-resolution display as claimed in claim 1 wherein the image blending algorithm is configured to correct for color imbalance in the blended image.

9. An ultra-resolution display as claimed in claim 1 wherein the image blending algorithm is configured to correct for geometric distortion, intensity errors, and color imbalance in the blended image.

10. An ultra-resolution display as claimed in claim 1 wherein the output resolution of the ultra-resolution display at the common display screen surpasses the resolution of respective input signals directed to the plurality of display devices.

11. An ultra-resolution display as claimed in claim 1 wherein the display devices are configured in an n×m array and the modified frustums overlap on the common display screen along one dimension of the array when n or m is equal to one and along two dimensions of the array when n and m are greater than one.

12. An ultra-resolution display as claimed in claim 1 wherein the image blending algorithm is configured to
convert an input video stream into sub-image video blocks representing respective spatial regions of the input video stream;
identify video block subscriptions for each of the display devices; and
operate the image projectors to project image data corresponding to the identified video block subscriptions such that the display devices collectively render a multi-display image representing the input video stream.

13. An ultra-resolution display as claimed in claim 12 wherein:
the video block subscriptions for each of the display devices are identified by matching a frustum of each display device with pixels of the sub-image video blocks; and
the frustum of each display device is matched with pixels of the sub-image video blocks by accounting for spatial offsets of each sub-image video block in the rendered image.

14. An ultra-resolution display as claimed in claim 1 wherein the image blending algorithm is configured to operate on a variable input corresponding to the screen displacement d such that the ultra-resolution display is operable at a plurality of different screen displacements d.

15. An ultra-resolution display comprising a plurality of display devices, a common display screen, and an image processor, wherein:
the common display screen is displaced from the display devices by a screen displacement d such that native frustums of respective ones of the display devices are expanded to define modified frustums that overlap on the common display screen;
the image processor is programmed to execute an image blending algorithm that is configured to generate a blended image on the common display screen by altering input signals directed to one or more of the display devices;
the image blending algorithm modifies input signal portions corresponding to overlapping pixels in the modified frustums of adjacent display devices by modifying pixel intensity values of adjacent display devices; and
the output resolution of the ultra-resolution display at the common display screen surpasses the resolution of respective input signals directed to the plurality of display devices.
